(19) United States
(12) Patent Application Publication
(10) Pub. No.: US 2017/0142750 A1
(43) Pub. Date: May 18, 2017

(54) Method for Signal Transmission in the Downlink of Multi-Hop Wireless Communication Systems

(71) Applicant: hyBee, Inc., Seongnam-si (KR)

(72) Inventors: Yong Hwan Lee, Seoul (KR); Jae Seok Bang, Seoul (KR); Jin Seok Han, Gunpo-si (KR)

(21) Appl. No.: 15/323,541

(22) PCT Filed: Jun. 30, 2015
(86) PCT No.: PCT/KR2015/006721

§ 371 Date: Jan. 3, 2017

(30) Foreign Application Priority Data
Jul. 2, 2014 (KR) 10-2014-0082597

(51) Int. Cl. H04W 74/00; H04W 28/02; H04W 74/08; H04W 56/00

(52) U.S. Cl. CPC H04W 74/006; H04W 56/0015; H04W 74/004; H04W 28/0278; H04W 74/08; H04W 88/12

(57) ABSTRACT

A method of signal transmission in the downlink of a multi-hop wireless communication system wherein a coordinator is connected to a plurality of routers and a plurality of end devices through one or more hops and wherein the coordinator and the routers maintain network synchronization by periodically transmitting a beacon signal In the management frame, a control message for system management is transmitted/received, and in the data frame, only devices which are to exchange data transmit and receive data while other devices turn their transceivers off to minimize power consumption.

### TECHNICAL FIELD

The present invention relates to signal transmission in the downlink of a multi-hop wireless communication system.

### BACKGROUND ART

As a transmission method in the downlink, a polling method in which a child device to receive data polls a parent device for the data is employed without use of a synchronization frame. The child device transmits a polling message to the parent device, and upon receiving the message, the parent device transmits an acknowledgement message (hereinafter, an ACK) to the child device and then, when the parent device has data to transmit to the child device, transmits the data to the child device. Upon successful reception of the data, the child device transmits an ACK to the parent device to notify successful reception of the data. The polling method does not require synchronization between devices, but as a matter of facts, a device operating as a parent device needs to keep its receiver always turned on, suffering from an idle listening problem, in which the receiver should be active for a long period of time even when data is not transmitted/received. Also, the polling method needs transmission and reception of a polling message and an ACK for transmission of each single data packet, yielding a severe signaling overhead for transmission of a large amount of data. In the polling method, since successful transmission of one data packet needs a successful 4-way handshake, data transmission performance may rapidly deteriorate in environments in which transmission errors occur frequently, such as in a co-channel interference environment. Also, polling messages may not successfully be transmitted due to a contention collision or a hidden node collision in the presence of a large number of child devices.

The idle listening problem in the polling method may be alleviated by using a fixed frame structure (hereinafter, a FFS) which is a medium access control (hereinafter, MAC) method specified by IEEE 802.15.4. In the FFS, a coordinator controlling a system and routers forming a multi-hop network use a super-frame comprising resources independent in time and frequency domain. The super-frame begins with transmission of a periodic beacon signal, and child devices of the coordinator and routers synchronize with their parent devices using the beacon signal. The parent device and child devices may reduce power consumption by using a duty-cycling structure in which a signal is transmitted and received during an active period, and when the active period is ended, the parent device and child devices stop transceiver operation during an inactive period. However, in the FFS, the parent device and child devices operate their transceivers in the super-frame of a fixed length even when data is not transmitted/received, still suffering from the idle listening problem. This problem may be alleviated by making the length of the super-frame in the FFS very small compared to the beacon interval (reduction of duty-cycle), which may significantly increase time for data transmission, in turn. In other words, there is a trade-off between power consumption and data transmission speed. Also, a pending method is provided in IEEE 802.15.4 super-frame structure for data transmission in the downlink, in which a parent device transmits a beacon signal including the data pending field, and upon receiving the beacon signal, a child device which is the destination of the data may receive the data after sending a data request message to the parent device. The pending method also need transmission and reception of a data request message and an ACK may need for transmission of each data packet as in the polling method, suffering from signaling overhead and also deteriorating transmission performance in interference environments.

### DETAILED DESCRIPTION OF THE INVENTION

### Technical Problem

It may not be feasible for a wireless sensor network (hereinafter, a WSN) in a low complexity/low power structure, such as ZigBee, to transmit a large amount of data. For example, in wireless price tag systems commercially applied to large mart stores, product information including the price of the product is transmitted to a display module, such as light-emitting device (LED), through a wireless channel in real time. When a size of a product information file is from dozens of kB to hundreds of kB, it may take a very long time and a very large power as well to transmit the product information to display modules by using commercial ZigBee devices.

### Technical Solution

The present invention relates to a transmission method to transmit a large amount of data in a WSN that has a small transmission capacity, and a basic concept is as follows. The present invention first uses a dynamic super-frame structure (hereinafter, a DFS) comprising management frames and data frames at a period of periodic beacon signals. In the management frame, a control message for network management and communication is transmitted/received, and a parent device transmits a beacon signal including a data pending field, notifying an absence or a presence of messages to a relevant child device. Upon receiving the beacon signal, a child device that has messages to receive transmits a data request message to its parent device, and child devices who do not have a message to receive stop transceiver operation to save power consumption. In the data frame, only parent and child device that have data to exchange transmit/receive data, and other devices turn their transceivers off to minimize power consumption. In the management frame, the parent device may repeatedly transmit a beacon signal and the child device may repeatedly transmit a data request message, thereby increasing transmission reliability of a control message in the downlink in operation environments where transmission errors frequently occur. In the data frame, only data is transmitted without transmission of additional control messages, and reliability of data transmission may be improved with an aid of channel sensing. As a consequence, the present invention alleviates the idle listening problem in the polling method and FFS, and also may provide performance improvement in transmission time and power consumption over the existing methods by increasing transmission reliability by means of channel sensing and repeated transmission of a beacon signal.

### Advantageous Effects

The present invention includes, in a wireless communication system in which a coordinator, a plurality of routers, and a plurality of end devices are connected to each other in one or more hops, use of a DFS comprising a management frame transmitting a control message and a data frame transmitting data, improvement of transmission reliability of control message in the downlink by means of repetitive transmission of a beacon signal and a data request message, determination of data packet length in the data frame, and data transmission after channel sensing in the data frame. The present invention makes all devices active in the management frame to transmit/receive control messages, while making only a pair of parent-child devices having data to transmit and receive active in the data frame and transmit/receive data, and making devices having no data to transmit and receive operate in a low duty-cycle, and thus alleviates the idle listening problem, which may significantly save power consumption compared to existing systems. Moreover, multi-hop data transmission in the downlink may be easier with the DFS with an aid of an acquiring/abandoning process for the use of a data frame. Also, by repeatedly transmitting a beacon signal and a data request message in the management frame, reliability of control message transmission is improved. Also, a packet length is appropriately determined in the data frame and data transmission begins only when the channel is confirmed to be clean after channel sensing, which may provide reliable transmission performance even in interference environments.

### DESCRIPTION OF THE DRAWINGS

FIG. 1 is a diagram of a system model including a coordinator, a plurality of routers, and a plurality of end devices.

FIGS. 2A and 2B are diagrams for describing a downlink data transmission method using a transmission frame structure suggested in the present invention. FIGS. 2A and 2B are connected to each other at a node A.

FIG. 3 is a flowchart of operations of a parent device and a child device.

FIGS. 4A and 4B are diagrams illustrating in detail operations of a parent device and a child device in a transmission frame structure suggested in the present invention. FIGS. 4A and 4B are connected to each other at a node B.

FIG. 5 is a diagram of operations of a parent device in a beacon period.

FIG. 6 is a diagram of operations of a parent device in a scheduling period.

FIG. 7 is a diagram of operations of a parent device in a contention access period.

FIG. 8 is a diagram of operations of a child device in a beacon period.

FIG. 9 is a diagram of operations of a child device in a scheduling period.

FIG. 10 is a diagram of operations of a child device in a contention access period.

FIG. 11 is a diagram of operations of a parent device in a data frame.

FIG. 12 is a diagram of operations of a child device in a data frame.

### BEST MODE

According to an aspect of the present invention, there is provided a data transmission method in a wireless communication system, wherein a coordinator transmits data to devices in the wireless communication system comprising a coordinator that manages a network operation, routers that are devices capable of accommodating child devices, and end devices that are devices incapable of accommodating child devices, wherein the coordinator and pluralities of the routers and the end devices form a network in a multi-hop cluster-tree structure, and wherein the coordinator and the routers maintain network synchronization by periodically transmitting a beacon signal, the data transmission method including: (A) using a periodic transmission frame comprising management frames for network management and data frames for data transmission; (B) transmitting and receiving, by devices in the network, control messages for network management and data transmission, in an interval of the management frame; and (C) transmitting and receiving, by devices determined by the control messages, data, in an interval of the data frame.

In (A), when Lmax denotes a maximum depth of the network (i.e., a number of hops between the coordinator and a device associated to the coordinator in a largest number of hops among devices in the network), the transmission frame may be configured so that Lmax management frames and Lmax data frames are not overlapped with each other in time, the coordinator or a router with a network depth of l−1 may operate as a parent device in the (nLmax+l)^{th} management frame, wherein lε{1, 2, . . . , Lmax} and nε{0, 1, 2, . . . }, and a device with a network depth of l may operate as a child device in the management frame, the coordinator or a router having a network depth of l−1 may operate as a parent device in the (nLmax+l)^{th} data frame, and a device having a network depth of l may operate as a child device in the data frame, the (nLmax+l)^{th} management frame may precede the (nLmax+l)^{th} data frame in time, and the coordinator or a router may transmit a beacon signal to its child devices at least once according to a transmission environment, and then begins management frame operation.

The management frame comprises a beacon interval in which a device operating as a parent device (i.e., the coordinator and a router) may transmit a beacon signal, a scheduling interval in which the device operating as a parent device transmits a downlink control message to its child devices, and a contention-based access interval in which child devices may transmit their uplink control message to their parent device in a contention-based manner.
(B) may include: when a parent device has a chance to transmit data in a data frame and has data to send to its child device (i.e., when the data is for its child device or when the data needs to be sent to its child device for delivery of the data to a destination device), transmitting, by the parent device, a data frame reservation message including an address of the final destination of the data; changing, by the child device that received the data frame reservation message, its transceiver operation into a normal transmission mode to receive data transmitted from its parent device in an interval of the data frame; and transmitting, by the child device that received the data frame reservation message, if the final destination of data included in a data frame reservation message is not itself, the data to its child devices when it has a chance of using a data frame in an interval of a next management frame.

(B) may include: when a child device has completed data transmission in the downlink or has received a notification message of completed transmission in the downlink from its child device, transmitting, by the child device, a notification message of completed transmission in the downlink to its parent device; and

when a parent device that has received the notification message of completed transmission in the downlink is not the coordinator, determining, by the parent device, to transmit a notification message of completed transmission in the downlink to its parent device to let the coordinator know the completed data transmission in the downlink and giving up the chance to use a data frame.

The transmitting of a data frame reservation message may include: when a parent device has a message for its child device, notifying, by the parent device, its child device a presence of control messages for its child device by transmitting a beacon signal including an address of its child device in a management frame; when a child device has successfully received the beacon signal in a management frame, transmitting, by the child device, a data request message to its parent device; and upon receiving the data request message, transmitting, by the parent device, the child device a data frame reservation message.

(C) may include: determining, by a device to send data in a data frame, a data packet size;

transmitting, by the device to transmit data in a data frame, data packets of the determined size only when it is confirmed that a channel environment is satisfactory for transmission; receiving, by the device to receive data in a data frame, the data packets and notifying the device transmitting the data packets a status of full data buffer by sending an acknowledgement message when its receiving buffer is full; when the interval of a data frame is ended or when a receiving data buffer of the device receiving the data is full, ending, by the device transmitting data and the device receiving data in the data frame, operation in the data frame; and notifying, by the device transmitting data in a data frame, the coordinator a completed transmission in the downlink after ending operation in the data frame.

The determining of a data packet size in a data frame may include: estimating, by the device to transmit data, a failure probability of packet transmission according to a data packet size; and determining, by the device to transmit data, a data packet size in consideration of the estimated failure probability of packet transmission and a size of a data packet header so that a transmission throughput is maximized.

The notifying of a completed transmission in the downlink to the coordinator may include: when a device receiving data in a data frame is a final destination of the data and all data packets are delivered to the device receiving data, notifying, by the device transmitting data, the coordinator a completed transmission in the downlink.

### MODE OF THE INVENTION

Hereinafter, one or more embodiments of the present invention will now be described with reference to accompanying drawings. In the description of the present invention, certain detailed explanations are omitted when it is deemed that they may unnecessarily obscure the essence of the invention. All terms which are used herein should be defined based on descriptions throughout the present specification.

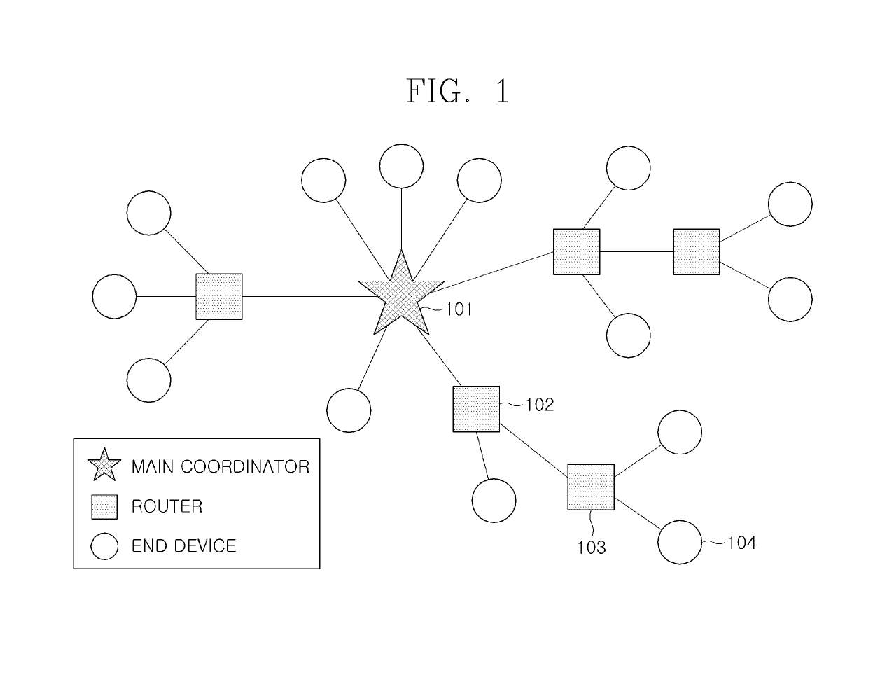

FIG. 1 illustrates a concept of a cluster tree structure-based WSN to which the present invention is applied. In FIG. 1, a coordinator manages a network, a router may have a child device, and an end device is connected to the coordinator or the router and is unable to have a child device. With respect to an arbitrary pair connected through one hop, a device connected to the coordinator through less hops is defined as a parent device, and a device connected to the coordinator through more hops is defined as a child device. In other words, the coordinator operates only as a parent device, the router operates as a parent device and also as a child device, and the end device operates only as a child device. Referring to such a structure of the cluster tree structure-based WSN with reference to FIG. 1, for example, based on a device 102 in such a WSN, the device 102 is a child device of a device 101 that is connected to a coordinator through less hops from among devices connected to the device 102, and the device 102 is a parent device of a device 103 connected to the coordinator through more hops.

The present invention considers using a dynamic super-frame structure including a management frame in which a control message is exchanged and a data frame in which data transmission is performed. In particular, the management frame includes a beacon period in which a beacon signal for network synchronization is transmitted, a scheduling period in which a control message for data transmission scheduling is exchanged, and a contention access period in which a control message for network management is exchanged. In the management frame, a device (a coordinator or a router) operating as a parent transmits a beacon signal in the beacon period, and exchanges, with a device operating as a child, a control message in the scheduling period and the contention access period. Meanwhile, in the management frame, a device operating as a child (a router or an end device) receives a beacon signal in the beacon period of the management frame of its parent device, and then operates as a child device in the scheduling period and the contention access period. In the management frame, only a control message is transmitted and received, and data is transmitted in the data frame.

When a size of downlink data is larger than one packet length, the data is transmitted after being split into several packets, and it is determined that the data transmitting of the data is completed when all of the packets reached a destination.

A control message used in the management frame includes a data frame reservation message, a downlink data transmission completion notification message, and a control message related to network connectivity maintenance. The data frame reservation message is transmitted from a parent device having data transmission authority in the data frame to a child device to which downlink data is to be transmitted by using the data frame so as to promise use of the data frame, and the data frame reservation message may include an address of a final destination of the downlink data. The downlink data transmission completion notification message is used to notify downlink data transmission completion, and includes an address of a final destination of transmission completed data.

For example, a transmission frame structure suggested in the present invention may have a structure in which Lmax management frames and Lmax data frames are repeated per beacon signal transmission period. Here, Lmax denotes the number of hops between the coordinator and a device connected to the coordinator through most hops from among devices in a network, i.e., a largest depth of the network. Here, a coordinator or router having a network depth of l−1 in a (lε{1, 2, . . . , Lmax})^{th} management frame operates as a parent, and a router or end device having a network depth of l operates as a child. Meanwhile, in a (1ε{1, 2, . . . , Lmax})^{th} data frame, data is transmitted from the coordinator or router having a network depth of l−1 to its child device.

Preferably, the management frames and the data frames are configured not to coextensively overlap each other, and in addition, adjacent devices do not transmit a beacon signal in the same time and frequency in order to prevent a collision between beacon signals in the beacon period of the management frame.

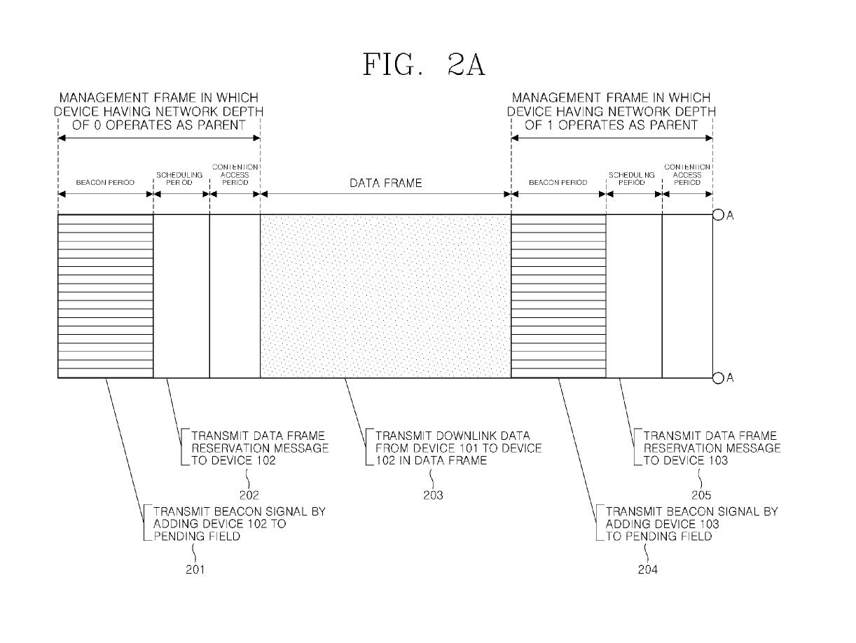

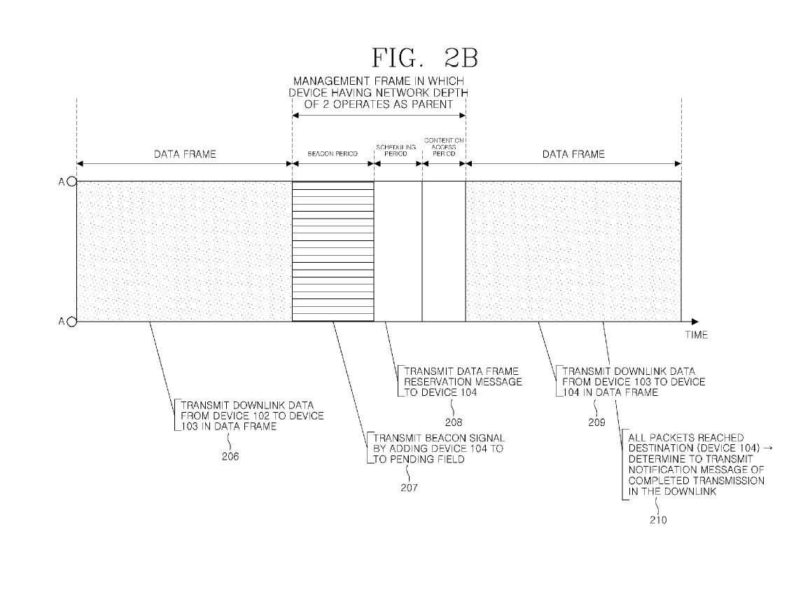

Multi-hop downlink data transmission processes according to an embodiment of the present invention will now be described in detail with reference to FIGS. 2A and 2B. FIGS. 2A and 2B illustrate processes of the devices 101, 102, and 103 of FIG. 1 transmitting downlink data through a multi-hop. Here, since a maximum depth Lmax of a network is 3, a transmission frame includes 3 management frames and 3 data frames per beacon signal transmission period.

Meanwhile, I_{Main,k} denotes a variable indicating whether a device k has data transmission authority in a data frame, and data is transmittable to a child device in the data frame by using the data frame when I_{Main,k} has a value of 1, whereas the data frame is not usable when I_{Main,k} has a value of 0. I_{Main,k} is set to 1 when the device k is a coordinator and is initialized to 0 when the device k is not a coordinator, such that only the coordinator has authority to use the data frame in the beginning. I_{main,k} is updated to 1 when the device received a data frame reservation message but is not a final destination and thus needs to transmit data to its child device, and accordingly, the device automatically acquires data transmission authority of the data frame in which the device operates as a parent. Also, I_{Main,k} is updated to 0 when downlink data transmission is determined to be completed or when a notification message of completed transmission in the downlink is received.

I_{Notify,k} is a variable indicating that the device k needs to transmit a notification message of completed transmission in the downlink to a parent device, and indicates that the message needs to be transmitted when I_{Notify,k} has a value of 1 and indicates that the message is not transmitted when I_{Notify,k} has a value of 0. I_{Notify,k} is initially set to 0, and is updated to 1 when the downlink data transmission is completed or when the notification message of completed transmission in the downlink is received. Also, I_{Notify,k} is updated to 0 when the notification message of completed transmission in the downlink is successfully transmitted to a parent.

In FIGS. 2A and 2B, since I_{Main,101}=1 initially, the device 101 has authority to use a data frame and transmits a data frame reservation message to the device 102 via downlink in a management frame so as to transmit downlink data to a device 104, i.e., a final destination. In order to transmit the message via downlink, a beacon signal including an address of the device 102 is transmitted in operation 201 in a beacon period, a data request message is received from the device 102 in a scheduling period, and then a data frame reservation message is transmitted to the device 102 in operation 202 to promise use of the data frame. Here, upon receiving the downlink listening message, the device 102 performs I_{Main,102}←1. Then, in the data frame, the device 101 transmits downlink data to the device 102, in operation 203.

The device 102 operates as a parent device in a management frame in which a device having a network depth of 1 operates as a parent, and here, since I_{main,102}=1, the data frame reservation message is transmitted to the device 103 via downlink in operations 204 and 205 so as to transmit the downlink data to the device 104, i.e., the final destination. Here, I_{Main,103}←1 is performed, and then data transmission is performed between the devices 102 and 103 in a next data frame, in operation 206. Transmission of the downlink data is performed between the device 103 and the device 104 in operations 207 through 209, in the same manner as above. Meanwhile, when all data is transmitted to the device 104 (i.e., when data transmission is completed), the device 103 performs I_{Main,103}←0 and I_{Notify,103}←1, in operation 210.

Then, the device 103 notifies the data transmission completion to the parent by transmitting a downlink data transmission completion notification message in a contention access period of a management frame in which the device 102 operates as the parent, and the message is transmitted to the coordinator in the similar manner. The coordinator starts next downlink data transmission when the notification message of completed transmission in the downlink is received.

The present invention enables a large amount of data to be transmitted via a multi-hop by using a data frame and a downlink data transmission completion notification as described above.

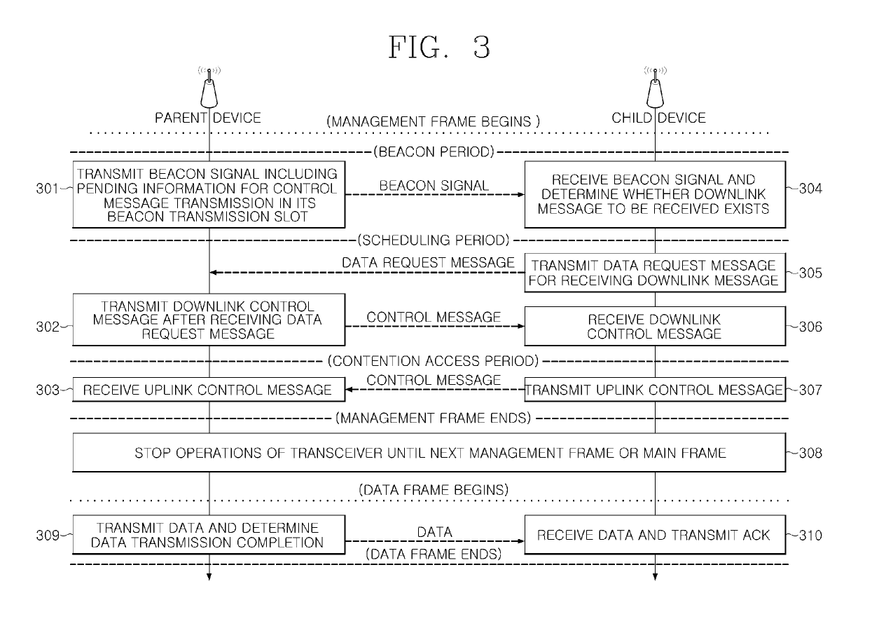

Overall operation processes of a parent device and a child device of the present invention are shown in FIG. 3. A management frame is used to transmit and receive a beacon signal, and to transmit uplink and downlink control messages. When the management frame begins, the parent device first transmits a beacon signal in its beacon transmission slot, in operation 301 of FIG. 3, and when a downlink control message is to be transmitted, pending information (i.e., notification indicating that a downlink message to be received by a child device exists, by indicating an address of the child device to which the downlink message is to be transmitted) is included in the beacon signal. In operation 304 of FIG. 3, the child device checks the pending information by receiving the beacon signal from the beacon transmission slot of the parent device, and when there is a downlink control message destined for it, operates in a scheduling period so as to receive the downlink control message.

The child device operating in the scheduling period transmits a data request message to the parent device in operation 305 of FIG. 3, and then receives the downlink control message in operation 306 of FIG. 3. Upon receiving the data request message, the parent device transmits the downlink control message to the child device in operation 302 of FIG. 3.

The child device having a control message to be transmitted via uplink transmits the control message to the parent device in operation 307 of FIG. 3, and the parent device waits to receive the uplink control message in operation 303 of FIG. 3. When an operation of the management frame is ended, the parent device and the child device reduce power consumption by stopping operations of a transceiver until a next operation interval in operation 308 of FIG. 3.

Meanwhile, a pair of the parent device and the child device may promise to use a data frame by transmitting and receiving a data frame reservation message in the management frame, and when operations in the data frame is promised, the relevant parent device and child device become active when the data frame begins. In the data frame, the parent device transmits data after sensing a channel in operation 309 of FIG. 3, and the child device transmits an ACK when the data is successfully received, in operation 310 of FIG. 3.

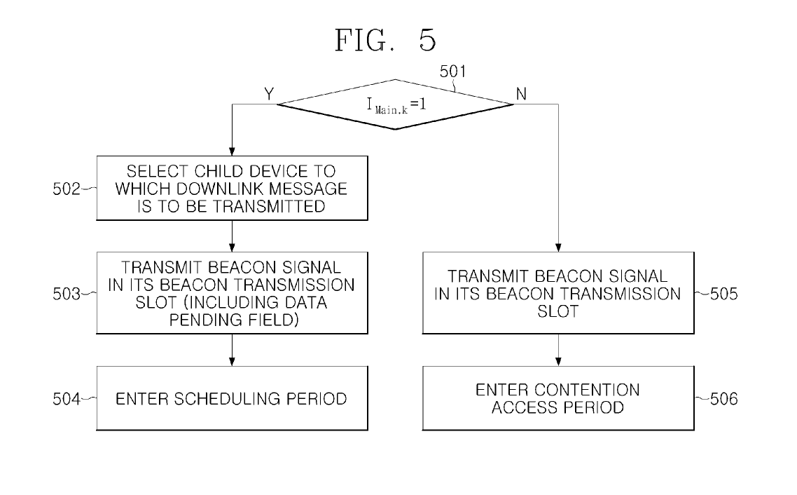

Processes of the device k, which operates as a parent, selecting a child device to which a downlink message is to be transmitted in a beacon period of a management frame and transmitting a beacon signal for synchronization in operation 301 are shown in FIG. 5. In the management frame, when it is determined that I_{Main,k}=1 (i.e., when it is determined that a data frame reservation message is to be transmitted via downlink in a current management frame for data transmission in a data frame), in operation 501 of FIG. 5, the parent device k selects the child device to which the downlink message is to be transmitted in operation 502 of FIG. 5. When a destination of data is its single hop child device by referring to a destination of data, which is initially stored in its buffer, the parent device selects the single hop child device as the child device to which the downlink message is to be transmitted. When the destination of data is a child device that is two or more hops away, the parent device selects, as the child device to which the downlink message is to be transmitted, a child device that has, as its child device, a device that is a destination of the data, from among its single hop child routers. The selecting of a router may be performed by using, for example, an address system-based tree routing method or a routing table-based source routing method.

The parent device adds an address of the child device selected in operation 502 to a data pending field in a beacon signal in operation 503 of FIG. 5, and transmits the beacon signal from its beacon transmission slot to notify the relevant child device about a message to be transmitted.

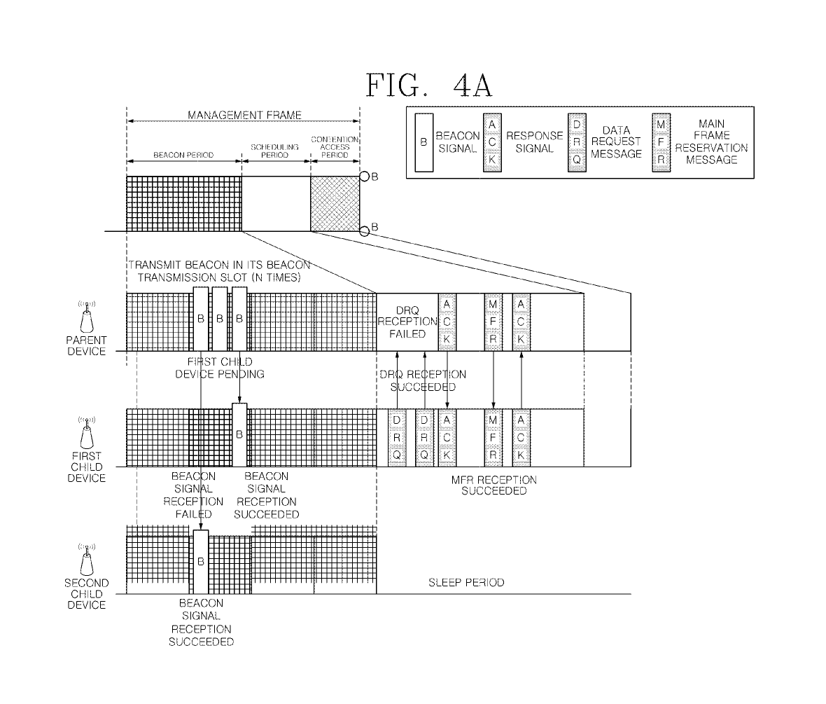

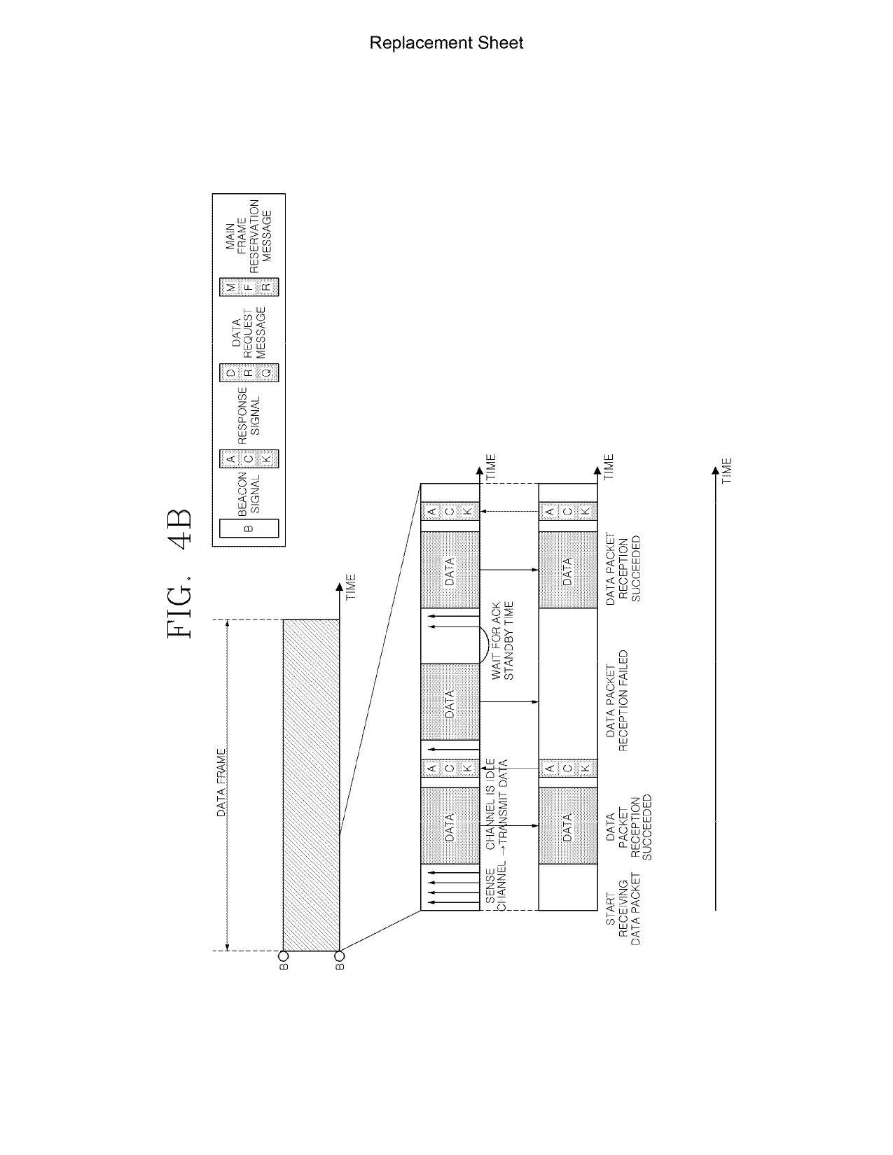

Meanwhile, when it is determined that I_{Main,k}=0 in operation 501, the parent device k transmits a beacon signal for synchronization in operation 505 of FIG. 5 and stops operating in a scheduling period, and enters a contention access period in operation 506 of FIG. 5. In operations 503 and 505, the beacon signal may be repeatedly transmitted in the beacon transmission slot in order to increase transmission reliability (see FIGS. 4A and 4B).

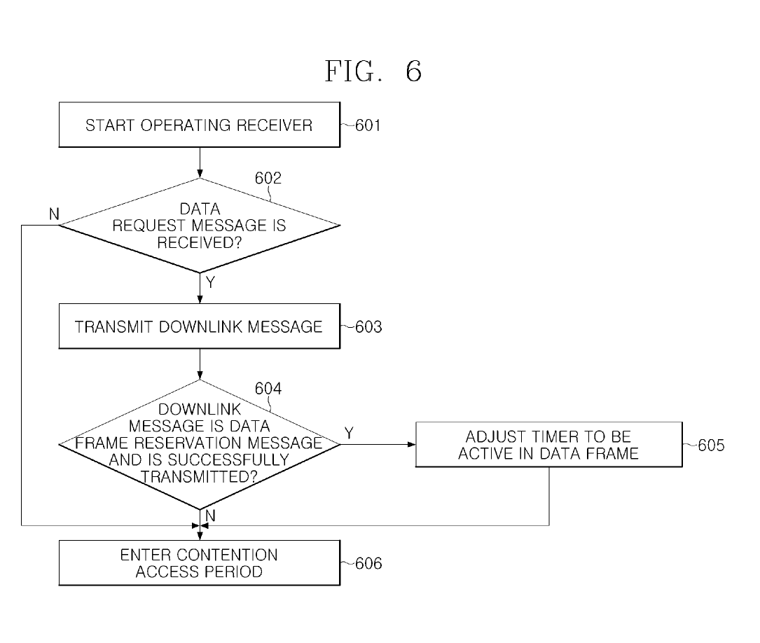

Processes of the device k, which operates as a parent in the management frame, transmitting a downlink message in a scheduling period of the management frame in operation 302 are shown in FIG. 6.

The parent device k starts operating a receiver in order to receive a data request message from a child device, in operation 601 of FIG. 6. When it is determined that the data request message is not received in operation 602 of FIG. 6, the parent device k may abort downlink message transmission and enter a contention access period in operation 606 of FIG. 6.

When it is determined that the data request message is received from the child device in operation 602, a downlink message is transmitted to the child device in operation 603. When it is determined that the downlink message is successfully transmitted and the downlink message is a data frame reservation message in operation 604 of FIG. 6, a timer is adjusted to be operable in a data frame in operation 605 of FIG. 6, and then operation 606 is performed. When not, the parent device k enters the contention access period in operation 606 without separately adjusting the timer.

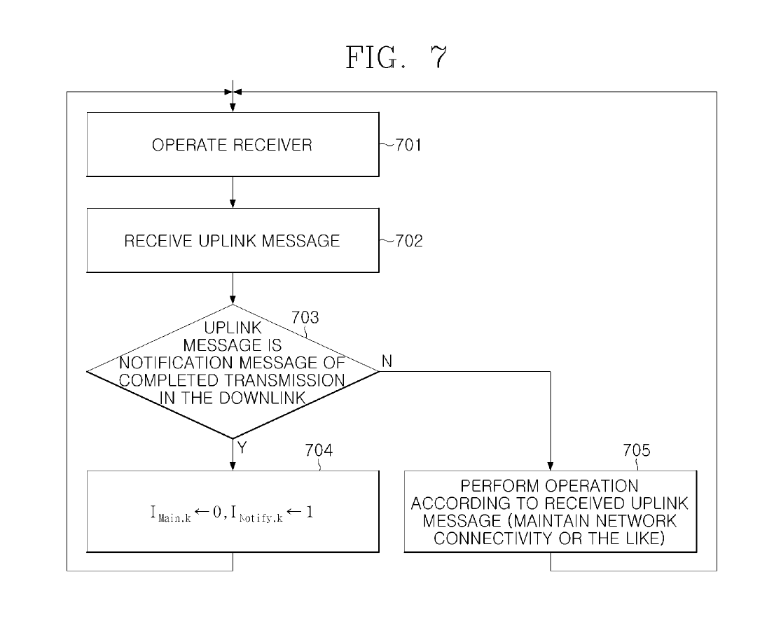

Processes of the device k, which operates as a parent in the management frame, receiving an uplink message in a contention access period of the management frame in operation 303 are shown in FIG. 7.

The parent device k operates the receiver in operation 701 of FIG. 7 such that the uplink message is received in the contention access period. When the uplink message is received in operation 702 of FIG. 7, a type of the uplink message is determined in operation 703 of FIG. 7. When it is determined that the uplink message is a notification message of completed transmission in the downlink, I_{Main,k}←0 and I_{Notify,k}←1 are performed in operation 704 of FIG. 7 such that the notification message of completed transmission in the downlink is transmitted to the coordinator. However, when it is determined that the uplink message is not a notification message of completed transmission in the downlink (i.e., when the uplink message is a control message related to network connectivity maintenance) in operation 703, an operation according to the type of the uplink message is performed in operation 705. The parent device that finished operations 704 and 705 may perform operation 701 and repeat above processes until the contention access period is ended.

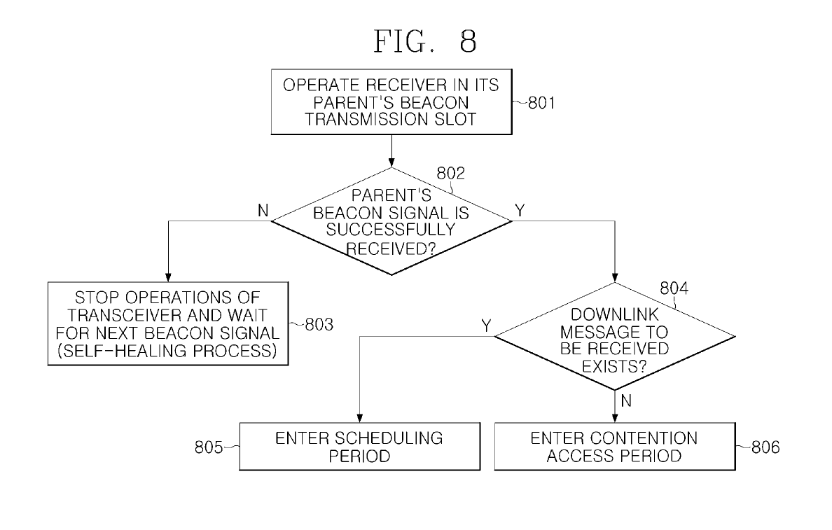

Processes of a device j, which operates as a child device in the management frame, receiving a beacon signal in the management frame and determining whether there is a downlink message to be received by examining a pending field in the beacon signal in operation 304 are shown in FIG. 8. The child device j operates a receiver for t_{RxOnDuration} seconds in operation 801 of FIG. 8 and waits for the beacon signal. When it is determined that the beacon signal is not received in operation 802 of FIG. 8, operation 803 of FIG. 8 is performed to stop operations of a transceiver and wait for a beacon signal of a next management frame.

However, when it is determined that the beacon signal is received in operation 802, operation 804 of FIG. 8 is performed to determine whether a downlink message destined for itself exists by examining a data pending field in the beacon signal. When it is determined that there is the downlink message to be received in operation 804, operations in a scheduling period is determined in operation 805 of FIG. 8. However, when it is determined that there is no downlink message to be received in operation 804, operations in the scheduling period is omitted and a contention access period is entered in operation 806 of FIG. 8.

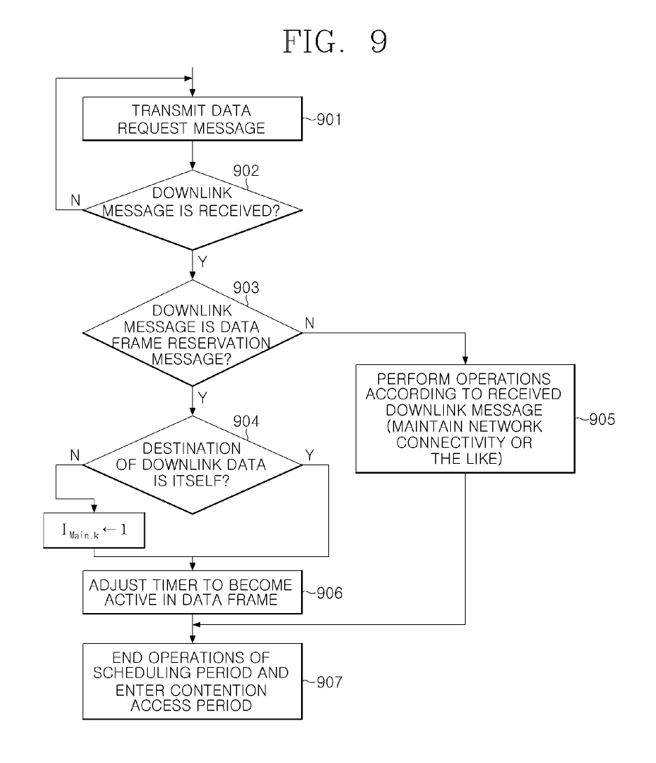

Processes of the device j, which operates as a child device in the management frame, transmitting a data request message for receiving a downlink message in a scheduling period of the management frame, and receiving the downlink message in the operations 305 and 306 are shown in FIG. 9.

The child device j transmits a data request message to a parent device in operation 901 of FIG. 9, and receives a downlink message in operation 902 of FIG. 9. When the downlink message is not received, operation 901 is performed and the data request message is re-transmitted to the parent device (see FIGS. 4A and 4B). However, when the downlink message is received, and when a data frame reservation message is received in operation 903 of FIG. 9, the child device j compares a final destination address of downlink data, which is recorded in the data frame reservation message, and its address. When it is determined that a final destination of the downlink data is itself, the child device j adjusts a timer to become active in a data frame and receive data in operation 906 of FIG. 9. When it is determined that the final destination of the downlink data is not itself (i.e., when data is to be transmitted via downlink), the child device j performs I_{Main,j}←1 to acquire data transmission authority of a data frame in which the child device j operates as a parent, and then performs operation 906.

Meanwhile, when it is determined that the downlink message is not a data frame reservation message (i.e., when the downlink message is a control message related to network connectivity maintenance or the like) in operation 903, the child device j performs operations according to a type of the downlink message, in operation 905 of FIG. 9. When operations 905 and 906 are ended, the child device j ends operations of a scheduling period and starts operations of a contention access period in operation 907 of FIG. 9.

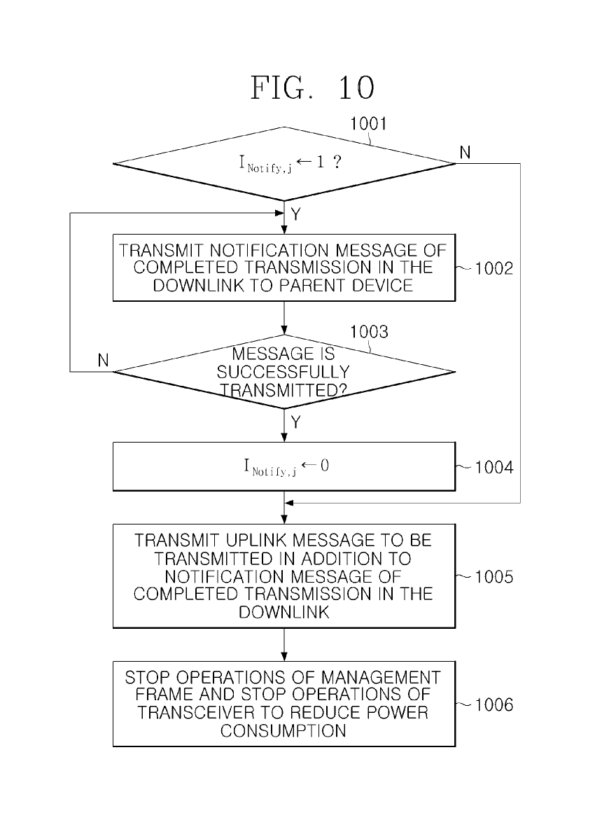

Processes of the device j, which operates as a child device in the management frame, transmitting an uplink message in a contention access period of the management frame in the operation 307 are shown in FIG. 10.

The child device j examines I_{Notify,j} and when it is determined that I_{Notify,j}=1 (i.e., when transmission completion of downlink data is to be notified to a parent device) in operation 1001 of FIG. 10, transmits a notification message of completed transmission in the downlink to the parent device in operation 1002 of FIG. 10. When the message is successfully transmitted to the parent device, I_{Notify,j}←0 is performed and then operation 1005 of FIG. 10 is performed.

However, when the notification message of completed transmission in the downlink is not successfully transmitted to the parent device, operation 1002 is performed and the notification message of completed transmission in the downlink is transmitted again.

In operation 1005, the child device transmits an uplink message to be transmitted (i.e., a message for network connectivity maintenance or the like) to the parent device in addition to the notification message of completed transmission in the downlink, and ends operations of the management frame and stops operations of a transceiver in order to reduce power consumption, in operation 1006 of FIG. 10. Here, the uplink message may be transmitted by using, for example, a MAC technology, such as carrier sense multiple access with collision avoidance.

The parent device and the child device, which finished downlink data transmission negotiation through the data frame reservation message in the management frame, stop operations of the transceiver after the management frame is ended, and become active in a data frame to transmit and receive downlink data.

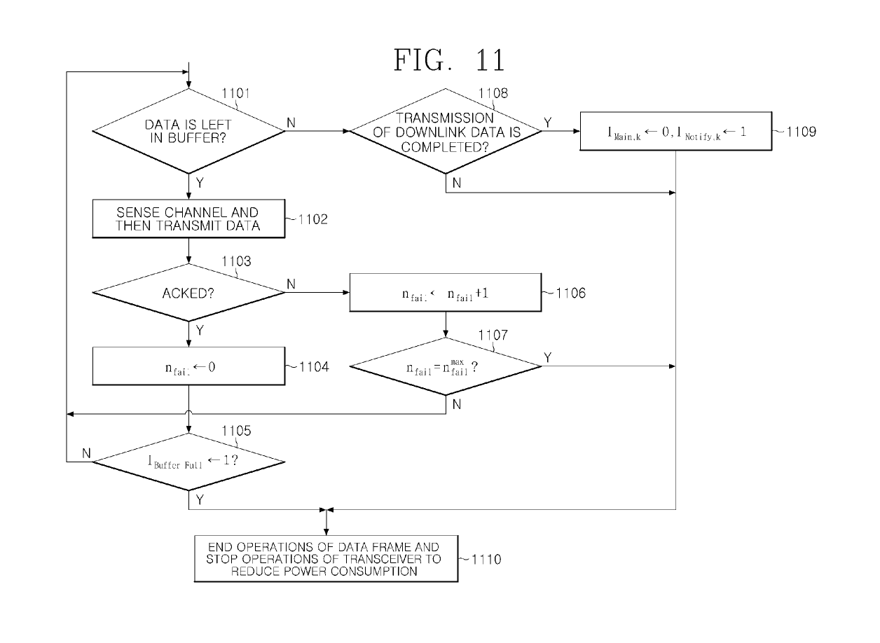

Operations of the device k, which operates as a parent device in a data frame, in the data frame in operation 309 according to an embodiment are shown in FIG. 11. Here, I_{BufferFull} denotes a buffer full flag in an ACK signal, and is set to be 1 when there is no more space in a buffer of a device transmitting an ACK and is set to be 0 when not.

The parent device k first examines whether there is data left in a buffer in operation 1101 of FIG. 11. When there is data left in the buffer, the parent device senses a channel in operation 1102 of FIG. 11, and then transmits the data to a child device that is a downlink destination when the channel is clean and performs an ACK standby operation. When an ACK is received in operation 1103 of FIG. 11, the parent device performs n_{fail}←0 in operation 1104 of FIG. 11, and performs operation 1105 of FIG. 11.

When I_{BufferFull}=1 in operation 1105, operation 1110 of FIG. 11 is performed to end operations of a data frame and stop operations of a transceiver to reduce power consumption. However, when I_{BufferFull}=0 in operation 1105, operation 1101 is performed to transmit a next data packet and repeat above operations.

However, when an ACK is not received in operation 1103, n_{fail}←n_{fail}+1 is performed in operation 1106 of FIG. 11, and when n_{fail}<n_{fail}^{max} in operation 1107 of FIG. 11, the data packet is re-transmitted in operation 1101. However, when n_{fail}=n_{fail}^{max} in operation 1107, the parent device k determines that a problem occurred in connectivity with the relevant child device, and thus does not transmit data and ends operations of the data frame in operation 1110 of FIG. 11.

When there is no data left in the buffer in operation 1101, it is determined whether transmission of downlink data is completed (i.e., whether a final destination of data transmitted in a current data frame is the child device and all downlink data is transmitted) in operation 1108 of FIG. 11. When the transmission of the downlink data is completed, the parent device k performs I_{Main,k}←0 and I_{Notify,k}←1 in operation 1109 of FIG. 11 to notify a coordinator about the downlink data transmission completion, and abandon transmission authority of the data frame to use the data frame no longer. Then, operation 1110 is performed to end operations of the data frame.

When the transmission of the downlink data is not completed (i.e., when the final destination of the data transmitted in the current data frame is not the child device and thus the data needs to be further transmitted to a next hop or when a packet is to be additionally received and transmitted to the child device in order to complete the transmission of the downlink data) in operation 1108, operation 1110 of FIG. 11 is performed to end operations of the data frame.

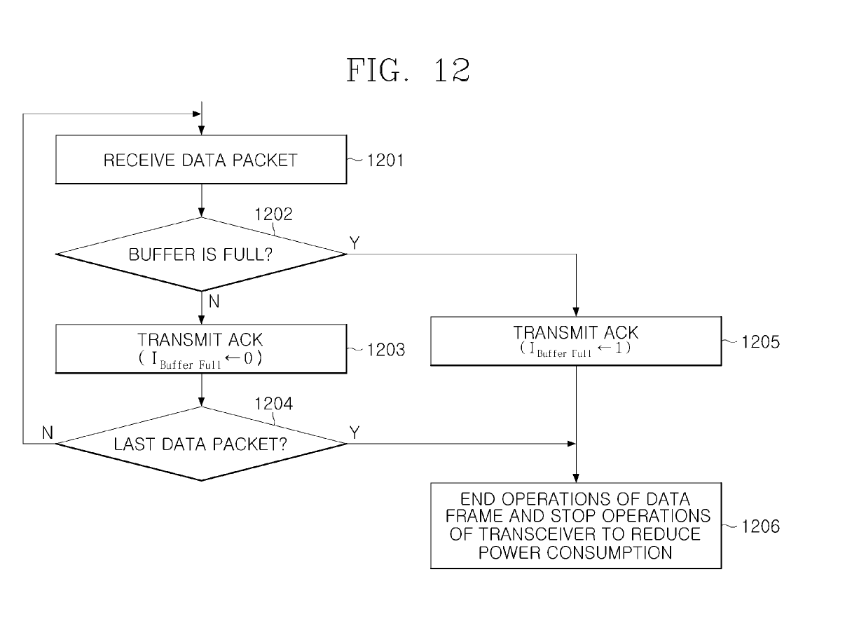

Operations of the device j, which operates as a child device in a data frame, in the data frame in operation 310 according to an embodiment are shown in FIG. 12.

The child device j receives a data packet from a parent device in operation 1201 of FIG. 12. When the data packet is received, the child device j records the data packet in its buffer, and checks its buffer in operation 1202 of FIG. 12. When the buffer is full, the child device j transmits an ACK including I_{BufferFull}←1 in operation 1205 of FIG. 12, and then ends operations of the data frame and stops operations of a transceiver to reduce power consumption in operation 1206 of FIG. 12.

When the buffer is not full in operation 1202, the child device j transmits an ACK including I_{BufferFull}←0 in operation 1203 of FIG. 12 and then performs operation 1204 of FIG. 12. The child device j determines whether the received packet is the last data packet (i.e., when a size of entire data is larger than a size of a packet, the entire data is split and transmitted in a plurality of packets, and thus it is determined whether the received packet is the last packet forming the entire data) in operation 1204, and when the received packet is not the last data packet, performs operation 1201 to wait for a next data packet. When the received packet is the last data packet, the child device j performs operation 1206 to end operations of the data frame.

According to the present invention, a parent device repeatedly transmits a beacon signal and a child device repeatedly transmits a data request message to increase reliability of control messages in the downlink even in a harsh interference environment. Also, since all devices maintain synchronization by only using a relatively short management frame and only a pair of parent device and child device, which are promised to operate in a data frame, transmit and receive data by operating in the data frame, resource waste may be greatly reduced compared to existing IEEE 802.15.4-based ZigBee FFS. As a consequence, the present invention may increase the speed of data transmission while minimizing the energy consumption.

1. A data transmission method in a wireless communication system, wherein a coordinator transmits data to devices in the wireless communication system comprising a coordinator that manages a network operation, a plurality of routers that are devices capable of accommodating child devices, and end devices that are devices incapable of accommodating child devices, wherein the coordinator and the plurality of routers and the end devices form a network in a multi-hop cluster-tree structure, and wherein the coordinator and the plurality of routers maintain network synchronization by periodically transmitting a beacon signal, the data transmission method including:
(A) using, by devices in the network, a periodic transmission frame comprising management frames for network management and data frames for data transmission;
(B) transmitting and receiving, by devices in the network, control messages for network management and data transmission, in an interval of the management frame; and
(C) transmitting and receiving, by devices determined by the control messages, data, in an interval of the data frame.

2. The data transmission method of claim 1, wherein, in (A),
when Lmax denotes a maximum depth of the network, the transmission frame is configured so that Lmax management frames and Lmax data frames are not overlapped with each other in time,
the coordinator or a router with a network depth of l−1 operates as a parent device in the (nLmax+l)^{th} management frame, wherein lε{1, 2, . . . , Lmax} and nε{0, 1, 2, . . . }, and a device with a network depth of l operates as a child device in the (nLmax+l)^{th} management frame,
the coordinator or a router with a network depth of l−1 operates as a parent device in the (nLmax+l)^{th} data frame, and a network device with a network depth of l operates as a child device in the (nLmax+l)^{th} data frame,
the (nLmax+l)^{th} management frame precedes the (nLmax+l)^{th} data frame in time, and
the coordinator or a router transmits a beacon signal to its child devices at least once according to a transmission environment, and then begins management frame operation.

3. The data transmission method of claim 1, wherein the management frame comprises a beacon interval in which a device operating as a parent device transmits a beacon signal, a scheduling interval in which the device operating as a parent device transmits a downlink control message to its child devices, and a contention-based access interval in which child devices transmit their uplink control message to their parent device in a contention-based manner.

4. The data transmission method of claim 1, wherein (B) comprises:
when a parent device has a chance to transmit data in a data frame and has data to send to its child device, transmitting, by the parent device, a data frame reservation message including an address of the final destination of the data;
changing, by the child device that received the data frame reservation message, its transceiver operation into a normal transmission mode to receive data transmitted from its parent device in an interval of the data frame; and
transmitting, by the child device that received the data frame reservation message, if the final destination of data included in a data frame reservation message is not itself, the data to its child devices when it has a chance of using a data frame in an interval of a next management frame.

5. The data transmission method of claim 1, wherein (B) comprises:
when a child device has completed data transmission in the downlink or has received a notification message of completed transmission in the downlink from its child device, transmitting, by the child device, a notification message of completed transmission in the downlink to its parent device; and
when a parent device that has received the notification message of completed transmission in the downlink is not the coordinator, determining, by the parent device, to transmit a notification message of completed transmission in the downlink to its parent device to let the coordinator know the completed data transmission in the downlink and giving up the chance to use a data frame.

6. The data transmission method of claim 4, wherein the transmitting of the data frame reservation message comprises:
when a parent device has a message for its child device, notifying, by the parent device, its child device a presence of control messages for its child device by transmitting a beacon signal including an address of its child device in a management frame;
when a child device has successfully received the beacon signal in a management frame, transmitting, by the child device, a data request message to its parent device; and
upon receiving the data request message, transmitting to, by the parent device, the child device a data frame reservation message.

7. The data transmission method of claim 1, wherein (C) comprises:
determining, by a device to send data in a data frame, a data packet size;
transmitting, by the device to transmit data in a data frame, data packets of the determined size only when it is confirmed that a channel environment is satisfactory for transmission;
receiving, by the device to receive data in a data frame, the data packets and notifying the device transmitting the data packets a status of full data buffer by sending an acknowledgement message when its receiving buffer is full;
when the interval of a data frame is ended or when a receiving data buffer of the device receiving the data is full, ending, by the device transmitting data and the device receiving data in the data frame, operation in the data frame; and
notifying, by the device transmitting data in a data frame, the coordinator a completed transmission in the downlink after ending operation in the data frame.

8. The data transmission method of claim 7, wherein the determining of a data packet size in a data frame comprises:
estimating, by the device to transmit data, a failure probability of packet transmission according to a data packet size; and
determining, by the device to transmit data, a data packet size in consideration of the estimated failure probability of packet transmission and a size of a data packet header so that a transmission throughput is maximized.

9. The data transmission method of claim 7, wherein the notifying of a completed transmission in the downlink to the coordinator comprises, when a device receiving data in a data frame is a final destination of the data and all data packets are delivered to the device receiving data, notifying, by the device transmitting data, the coordinator a completed transmission in the downlink.

10. The data transmission method of claim 2, wherein the maximum depth of the network comprises a number of hops between the coordinator and a device associated to the coordinator in a largest number of hops.

11. The data transmission method of claim 2, wherein the management frame comprises a beacon interval in which a device operating as a parent device transmits a beacon signal, a scheduling interval in which the device operating as a parent device transmits a downlink control message to its child devices, and a contention-based access interval in which child devices transmit their uplink control message to their parent device in a contention-based manner.

12. The data transmission method of claim 3, wherein the parent device is the coordinator or a router.

13. The data transmission method of claim 11, wherein the parent device is the coordinator or a router.

14. The data transmission method of claim 4, wherein the transmitting, by the parent device, of the data frame reservation message occurs when the data is for its child device or when the data needs to be sent to its child device for delivery of the data to a destination device.
